(19) United States
(12) Patent Application Publication
(10) Pub. No.: US 2010/0197878 A1
(43) Pub. Date: Aug. 5, 2010

(54) POLYOL BLENDS FOR USE IN MAKING POLYMERS

(75) Inventors: Francois M. Casati, Pfaffikon (CH); Christopher Noakes, Richterswil (CH)

Correspondence Address: The Dow Chemical Company, P.O. BOX 1967, Midland, MI, 48641, US

(73) Assignee: DOW GLOBAL TECHNOLOGIES INC., MIDLAND, MI (US)

(21) Appl. No.: 12/672,122

(22) PCT Filed: Jul. 24, 2008
(86) PCT No.: PCT/US08/71048

§ 371 Date: Feb. 4, 2010

Related U.S. Application Data
(60) Provisional application No. 60/963,704, filed on Aug. 6, 2007.

(51) Int. Cl. C08G 18/32; C09K 3/00; C08G 65/34; C08G 63/00; C08G 73/00; C08F 118/02

(52) U.S. Cl. 526/319; 252/182.24; 528/425; 528/271; 528/65; 528/422

(57) ABSTRACT

A composition comprises (A) a blend of (a) at least one first natural oil polyol prepared by a first process, and (b) at least one second natural oil polyol different from the first natural oil polyol, prepared by a second process; or (B) a prepolymer prepared from at least one first natural oil polyol prepared by a first process, and (b) at least one second natural oil polyol different from the first natural oil polyol, prepared by a second process; or (C) at least one prepolymer prepared from (a) at least one first natural oil polyol prepared by a first process, and (b) at least one second natural oil polyol different from the first natural oil polyol, prepared by a second process. Polymer preparable from a composition of the invention and at least one monomer interpolymerizable therewith. The polymer is most preferably a polyurethane. A process of preparing a polymer comprises (a) admixing at least one such composition with at least one monomer interpolymerizable therewith. Articles comprise at least one resulting polymer.

### CROSS-REFERENCE TO RELATED APPLICATIONS

This application claims benefit of U.S. Provisional Patent Application Ser. No. 60/963,704, filed Aug. 6, 2007, entitled “Polyol Blends for Use in Making Polymers” which is herein incorporated by reference.

### BACKGROUND

This invention involves blends of polyols, preferably polyol blends useful in making polymers such as polyurethanes as well as products incorporating such polymers and processes of making the blends, polymers and products.

Polyols have been prepared from renewable resources, namely natural oils, preferably seed oils in a number of ways including epoxidation, hydroxylation, esterification, hydroformylation, alkoxylation and the like. Each process results in polyols with specific properties such as functionality, reactivity, molecular weight. For instance US 2006/0041157 (Petrovic) teaches epoxidation of vegetable oil followed by hydroformylation and hydrogenation. WO 2006/116456 (Cargill) teaches oligomeric polyols formed from vegetable oils by epoxidation, ring opening and polymerization and their use in polyurethane foams. US 2006/0229375 (Bayer) teaches use of alkyoxylated vegetable oil hydroxylate in polyurethane foams or elastomers. US2006/0235100 (Bayer) teaches use of vegetable oil hydroxylate in combination with conventional polymer polyol and aliphatic polyhydroxy alcohols in polyurethane foams. WO2006/012344 (Pittsburg State University) teaches use of vegetable oil polyols modified by epoxidation and ring opening using a ring opener such as a reduced hydroformylated vegetable oil derived polyol. US 2005/007062 (Herrington) teaches a variety of methods of making a natural oil polyol, and the use of the individual resulting polyols, including the reaction product of two such resulting polyols in making flexible polyurethane foams. WO 2004/096882 and 2004/096883 teach processes of forming hydroxymethyl containing polyester polyols and their use in flexible polyurethane foams. WO 2004/020497 (BASF) teaches production of polyols by double metal cyanide (DMC) catalyzed alkoxylation of castor oil and its use in a low emission polyurethane soft foam. US 2007/0123725 (Bayer) teaches use of DMC to alkoxylate epoxidized unsaturated oils. U.S. Pat. No. 6,548,609 claims reaction of epoxidized vegetable oil with a dialcohol, a polyalcohol, an alkanolamine or a mixture thereof.

The advantages of using renewable resources in making polymers are widely recognized. However, several practical limits to the amount of renewable content have arisen. For instance, numerous ways of using polyols from renewable resources have been disclosed, but most involve use of a renewable source polyol with at least one conventional polyol, such as a polyether polyol. In some instances the conventional polyol is used to achieve certain desirable properties in a resulting polymer. In other instances, the conventional polyol is used because of its compatibility with other ingredients in a formulation, for instance water. See US 2005/0070620 examples 13 to 18 showing a worsening of foam 50% Compression sets when the level of NOP is increased. Indeed foams containing 20 and 30 parts of NOP (examples 14, 15, 17 and 18 in that reference) have unacceptable values of compression sets. U.S. Pat. No. 6,548,609 discloses polyols with functionality higher than 5, hence this type of polyol cannot be used by itself in flexible foams. Similarly castor oil or lesquerella oil have high functionality and, therefore are not used alone to make flexible foams.

### SUMMARY OF THE INVENTION

It has now been discovered that a combination of different renewable source or natural oil polyols, preferably prepared by different processes, can often be used to make up a larger proportion of a polymer than can one of the individual renewable source polyols of the combination when used alone or such a combination results in more desirable physical properties or a higher level of renewable content in a resulting polymer than does any component of the combination alone. Alternatively, combining natural oil polyols is sometimes observed to improve foam processing, this is believed to result from the observation that some natural oil polyols are more hydrophobic, are more or less reactive, or have higher functionality than may be optimum for some formulations. Combinations of natural oil polyols often ameliorate these less than optimum qualities. A combination of different natural oil polyols preferably exhibits satisfactory properties at a higher level of renewable resources, improved properties over essentially the same end product produced using one of the natural oil polyols alone in an amount equal to that of the combination, an improvement in processing or, more preferably a combination thereof.

The invention includes a composition of (a) at least one first natural oil polyol, (b) at least one second natural oil polyol different from the first natural oil polyol. The first and second natural oil polyols preferably are sufficiently different to result in improved physical or processing properties, satisfactory properties at a higher level of renewable resources or when using a larger amount of combined natural oil polyols in a resulting polymeric product or a combination thereof, all as compared with essentially the same end product produced by essentially the same process but using one of the natural oil polyols alone in an amount equal to that of the combination of natural oil polyols. Preferably the blend does not contain polyols not at least partially derived from natural oils. However it is often desirable, especially in the case of flexible foams, to additionally include at least one polyol from other than a natural oil source, preferably in an amount of at least about 2, at most about 90 PHP or a combination thereof.

Alternatively, at least one of the natural oil polyols is used in a prepolymer such that compositions of the invention include (1) (a) a prepolymer prepared from at least one first natural oil polyol prepared by a first process, and (b) at least one second natural oil polyol different from the first natural oil polyol, prepared by a second process; or (2) at least one prepolymer prepared from (a) at least one first natural oil polyol prepared by a first process, and (b) at least one second natural oil polyol different from the first natural oil polyol, prepared by a second process.

In another aspect, the invention is a polymer preparable from such a blend and at least one monomer interpolymerizable with the blend. The polymer is preferably a polyurethane. Independently, the monomer is preferably at least one isocyanate compound.

In another aspect, the invention is a process of preparing a polymer comprising admixing at least one polyol blend comprising at least 2 different natural oil polyols with at least one monomer interpolymerizable therewith, preferably comprising at least one isocyanate compound.

In another aspect, the invention is a process of preparing a polymer admixing at least one first natural oil polyol and an isocyanate prepolymer made using at least one second natural oil polyol, different from the first natural oil polyol.

In yet another aspect, the invention is an article comprising at least one polymer prepared from a combination of at least two different natural oil polyols. The article is more preferably a foam, most preferably a flexible foam.

### DETAILED DESCRIPTION OF THE INVENTION

### Definitions

The term “resilience” or “resiliency” is used to refer to the quality of a foam perceived as springiness. It is measured according to the procedures of ASTM D3574 Test H. This ball rebound test measures the height a dropped steel ball of known weight rebounds from the surface of the foam when dropped under specified conditions and expresses the result as a percentage of the original drop height.

The term “ball rebound” is used herein to refer to result of test procedure of ASTM D3574-Test H as previously described.

The term “density” is used herein to refer to weight per unit volume of a foam. Density is determined according to the procedures of ASTM D357401, Test A.

The term “tensile strength” as applied to a foam is used herein to refer to the maximum force which a dogbone shaped foam sample can bear while being extended under linear (uniaxial) extensional force. The stress is increased until the material reaches a break point at which time the load and extension at break are used to calculate the tensile strength and the elongation, all determined according to the procedures of ASTM D-3574, Test E and is measured in pounds per square inch (PSI) or kilopascals (kPa).

The term “ultimate elongation” as applied to a foam is used herein to refer to the linear extension which a sample of foam can attain before rupture. The foam is tested by the same method used to determine tensile strength, and the result is expressed as a percentage of the original length of the foam sample according to the procedures of ASTM D-3574, Test E.

The term “tear strength” is used herein to refer to the maximum average force required to tear a foam sample which is pre-notched with a slit cut lengthwise into the foam sample. The test results are determined according to the procedures of ASTM D3574-F in pounds per linear inch (PLI) or in Newtons per meter (N/m).

The term “load at 25% deflection” is used herein to refer to the force required to displace a foam sample of dimensions 4 in×4 in×2 in thickness (10.16×10.16×5.08 cm) to 75% of its original thickness determined according to the procedures of ASTM D 3574 B and is measured in pounds force (lbF) or in Newtons (N). Similarly loads at 65% and 75% deflections refer to the forces required to compress a foam of dimension (4 in×4 in×2 in thickness) (10.16×10.16×5.08 cm) to 35% or 25% of its original foam height, respectively.

The term “recovery time” is used herein to refer to the time it takes a foam to recover after compression, an applied force of 1 pound of force (4.45 N), which is determined according to the procedures of ASTM D-3574M and is measured in seconds.

The term “CS 75% Parallel-CT” stands for compression set test measured at the 75% compressive deformation level and parallel to the rise direction in the foam. This test is used herein to correlate in-service loss of cushion thickness and changes in foam hardness. The compression set is determined according to the procedures of ASTM D 3574-95, Test I. and is measured as percentage of original thickness of the sample. Similarly, “CS 90% Parallel-CT” refers to the same measurement as above (compression set), but this time measured at 90% compressive deformation level of the sample, parallel to the rise direction in the foam.

The term “air flow” refers to the volume of air which passes through a 1.0 inch (2.54 cm) thick 2 inch×2 inch (5.08 cm) square section of foam at 125 Pa (0.018 psi) of pressure. Units are expressed in cubic decimeters per second and converted to standard cubic feet per minute. A representative commercial unit for measuring air flow is manufactured by TexTest AG of Zurich, Switzerland and identified as TexTest Fx3300. This measurement follows ASTM D 3574 Test G.

The term “hardness” refers to that property measured by the procedures of ASTM D 3574, Test B which corresponds to IFD. Specifically 65% IFD is used herein as a measure of hardness.

The term “modulus of elasticity” or “elasticity modulus” is a measure of material stiffness. It is the proportionality factor that relates the change in unit length of a material in response to a unit stress within the linear elastic limits, and is a characteristic of the material. The modulus of elasticity is obtained by dividing the applied force by the cross sectional area of the material normal to the applied force, to obtain the applied stress; this stress is then divided by the resulting strain to obtain modulus. Modulus of elasticity is measured according to the procedures of ASTM D-638.

The term “NCO Index” means isocyanate index, as that term is commonly used in the polyurethane art. As used herein as the equivalents of isocyanate, divided by the total equivalents of isocyanate-reactive hydrogen containing materials, multiplied by 100. Considered in another way, it is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

As used herein, “polyol” refers to an organic molecule having an average of greater than 1.0 hydroxyl groups per molecule. It may also include other functionalities, that is, other types of functional groups.

As used herein the term “conventional polyol” is used to designate a polyol of other than vegetable or animal origin, preferably of petroleum origin, within the skill in the art for use in polyurethanes or other polymers. The term “conventional polyether polyol” is used for a polyol formed from at least one alkylene oxide, preferably ethylene oxide, propylene oxide or a combination thereof, and not having a part of the molecule derived from a vegetable or animal oil, a polyol of the type commonly used in making polyurethane foams. A polyether polyol can be prepared by known methods such as by alkoxylation of suitable starter molecules. Such a method generally involves reacting an initiator such as, water, ethylene glycol, or propylene glycol, with an alkylene oxide in the presence of a catalyst such as KOH or DMC. Ethylene oxide, propylene oxide, butylene oxide, or a combination of these oxides can be particularly useful for the alkoxylation reaction. A polyether polyol, for instance polyoxyethylene polyol can contain alkyl substituents. The process for producing polyether polyols can involve a heterogeneous feed of a mixture of alkylene oxides, a sequential feed of pure or nearly pure alkylene oxide polyols to produce a polyol with blocks of single components, or a polyol which is capped with, for example, ethylene oxide or propylene oxide. These types of polyols preferably having an unsaturation below 0.1 mequiv/g are all known and used in polyurethane chemistry. In addition to polyether polyols, conventional polyols include, for instance, polyester polyols, polycaprolactone polyols or combinations thereof.

The term “natural oil polyol” (hereinafter NOP) is used herein to refer to compounds having hydroxyl groups which compounds are isolated from, derived from or manufactured from natural oils, including animal and vegetable oils, preferably vegetable oils. Examples of vegetable and animal oils that may be used include, but are not limited to, soybean oil, safflower oil, linseed oil, corn oil, sunflower oil, olive oil, canola oil, sesame oil, cottonseed oil, palm oil, rapeseed oil, tung oil, fish oil, or a blend of any of these oils. Alternatively, any partially hydrogenated or epoxidized natural oil or genetically modified natural oil can be used to obtain the desired hydroxyl content. Examples of such oils include, but are not limited to, high oleic safflower oil, high oleic soybean oil, high oleic peanut oil, high oleic sunflower oil (such as NuSun sunflower oil), high oleic canola oil, and high erucic rapeseed oil (such as Crumbe oil). Natural oil polyols are well within the knowledge of those skilled in the art, for instance as disclosed in Colvin et al., UTECH Asia, Low Cost Polyols from Natural Oils, Paper 36, 1995 and “Renewable raw materials—an important basis for urethane chemistry:” Urethane Technology: vol. 14, No. 2, Apr./May 1997, Crain Communications 1997, WO 01/04225, WO 40/96882; WO 40/96883; U.S. Pat. No. 6,686,435, U.S. Pat. No. 6,433,121, U.S. Pat. No. 4,508,853, U.S. Pat. No. 6,107,403, US Pregrant publications 20060041157, and 20040242910.

The term “natural oil derived polyol” is used herein to refer to NOP compounds which are derived from natural oils. For instance, natural oils or isolates therefrom are reacted with compounds ranging from air or oxygen to organic compounds including amines and alcohols. Frequently, unsaturation in the natural oil is converted to hydroxyl groups or to a group which can subsequently be reacted with a compound that has hydroxyl groups such that a polyol is obtained. Such reactions are discussed in the references in the preceding paragraph.

The term “prepolymer” is used to designate a reaction product of monomers which has remaining reactive functional groups to react with additional monomers to form a polymer.

The term “natural oil based prepolymer” or “natural oil prepolymer” is used herein to describe prepolymers comprising at least one natural oil polyol reacted with at least one monomer reactive therewith in an amount in excess of that amount necessary to form a polymer such that the resulting prepolymer has functional groups remaining that are reactive with hydroxyl groups. For instances, when at least one isocyanate is the reactive monomer, isocyanate prepolymers of natural oil polyols are formed. Forming and using such prepolymers are within the skill in the art such as disclosed by WO 2006/047434 which is incorporated herein by reference to the fullest extent permitted by law.

The term “renewable resource” is used herein to designate animal and plant fats or oils as distinguished from, for instance, petroleum oils and derivatives.

The terms “natural oil content,” “level of renewable resource,” “renewable resource content,” and “level of natural oil” all refer to that weight percentage of the combination of polyols and monomers reactive therewith in a final polymer which has a plant or animal oil or fat as its origin. For instance, if a vegetable oil with a molecular weight of 1000 and having 3 double bonds is fully epoxidized and each ring is opened using a molecule of other than plant or animal oil origin with a molecular weight of 150 to make a triol, which is then reacted with three moles of a petroleum based monomer (for instance, an isocyanate) having an equivalent weight of 333, the level of renewable resource is 1000/(1000+3*17+3*150+3*333)=40%. If the same vegetable oil is hydroformylated and reduced to convert the 3 double bonds to hydroxymethyl groups, the calculation is 1000/(1000+3*18+3*333)=48.7%.

The term “hydroxyl number” indicates the concentration of hydroxyl moieties in a composition of polymers, particularly polyols. A hydroxyl number represents mg KOH/g of polyol. A hydroxyl number is determined by acetylation with pyridine and acetic anhydride in which the result is obtained as the difference between two titrations with KOH solution. A hydroxyl number may thus be defined as the weight of KOH in milligrams that will neutralize the acetic anhydride capable of combining by acetylation with 1 gram of a polyol. A higher hydroxyl number indicates a higher concentration of hydroxyl moieties within a composition. A description of how to determine the hydroxyl number for a composition can be found in texts well-known in the art, for example in Woods, G., The ICI Polyurethanes Book—2nd ed. (ICI Polyurethanes, Netherlands, 1990).

The term “primary hydroxyl group” means a hydroxyl group (—OH) on a carbon atom which has only one other carbon atom attached to it, (preferably which has only hydrogen atoms attached thereto) (—CH₂—OH). A secondary hydroxyl group is on a carbon atom having 2 carbon atoms attached thereto.

The term “functionality” particularly “polyol functionality” is used herein to refer to the number of hydroxyl groups in a polyol.

All percentages, preferred amounts or measurements, ranges and endpoints thereof herein are inclusive, that is, “less than about 10” includes about 10. “At least” is, thus, equivalent to “greater than or equal to,” and “at most” is, thus, equivalent “to less than or equal to.” Numbers herein have no more precision than stated. Thus, “115” includes at least from 114.5 to 115.49. Furthermore, all lists are inclusive of combinations of two or more members of the list. All ranges from a parameters described as “at least,” “greater than,” “greater than or equal to” or similarly, to a parameter described as “at most,” “up to,” “less than,” “less than or equal to” or similarly are preferred ranges regardless of the relative degree of preference indicated for each parameter. Thus a range that has an advantageous lower limit combined with a most preferred upper limit is preferred for the practice of this invention. All amounts, ratios, proportions and other measurements are by weight unless stated otherwise. All percentages refer to weight percent based on total composition according to the practice of the invention unless stated otherwise. Except in the examples, or where otherwise indicated, all numbers expressing quantities, percentages, OH numbers, functionalities and so forth in the specification are to be understood as being modified in all instances by the term “about.” Unless stated otherwise or recognized by those skilled in the art as otherwise impossible, steps of processes described herein are optionally carried out in sequences different from the sequence in which the steps are discussed herein. Furthermore, steps optionally occur separately, simultaneously or with overlap in timing. For instance, such steps as heating and admixing are often separate, simultaneous, or partially overlapping in time in the art. Unless stated otherwise, when an element, material, or step capable of causing undesirable effects is present in amounts or in a form such that it does not cause the effect to an unacceptable degree it is considered substantially absent for the practice of this invention. Furthermore, the terms “unacceptable” and “unacceptably” are used to refer to deviation from that which can be commercially useful, otherwise useful in a given situation, or outside predetermined limits, which limits vary with specific situations and applications and may be set by predetermination, such as performance specifications. Those skilled in the art recognize that acceptable limits vary with equipment, conditions, applications, and other variables but can be determined without undue experimentation in each situation where they are applicable. In some instances, variation or deviation in one parameter may be acceptable to achieve another desirable end.

The term “comprising”, is synonymous with “including,” “containing,” or “characterized by,” is inclusive or open-ended and does not exclude additional, unrecited elements, material, or steps. The term “consisting essentially of” indicates that in addition to specified elements, materials, or steps; elements, unrecited materials or steps may be present in amounts that do not unacceptably materially affect at least one basic and novel characteristic of the subject matter. The term “consisting of” indicates that only stated elements, materials or steps are present.

This invention comprises at least one polyol blend comprising at least two different natural oil polyols. In one preferred embodiment, each prepared by a process different from the process used to prepare the other. The term “different natural oil polyols” is used herein to designate polyols at least partially derived from renewable resources, particularly vegetable or animal oils or fats, more preferably vegetable oils, which are sufficiently different, for instance in terms of physical characteristics (such as hydrophobicity/hydrophilicity, viscosity, color, odor or a combination thereof), chemical structure (such as molecular weight, functionality, level of natural oil, level of saturates, or a combination thereof), reactivity (such as percent primary or secondary hydroxyls, amine groups, autocatalytic moieties, or a combination thereof), type of natural oil raw material or a combination thereof, that a mixture of two or more of the natural oil polyols can be used to make up a larger proportion of a polymer or a polymer with a higher level of renewable content or natural oil than can any of the individual natural oil polyols of the combination when used individually in essentially the same formulation to produce a product of comparable properties; such that a combination of the different natural oil polyols results in at least one improvement in processing, one more desirable physical property in a resulting polymer or end product comprising the polymer or combination thereof than does any natural oil polyol component of the combination individually. Those skilled in the art recognize that most natural oil polyols are, themselves, mixtures of slightly varying molecules. In the description of this invention such mixtures are not considered mixtures, combinations, blend or compositions of at least two different polyols. Instead, each such natural mixture or mixture resulting from natural variations, even when the variation is optionally altered by processes such as purification, is considered one natural oil polyol having properties which are known by those skilled in the art to be an average of the properties of the slightly varying molecules. The different natural oil polyols are preferably produced by different processes, that is, processes sufficiently different to produce products having the aforementioned differences. In one embodiment, preferably, different processes vary by more than at least one of reaction temperature, reaction time, reaction pressure, catalyst or starting material unless such variation results in substantially different products, which for the practice of this invention means polyol products sufficiently different to result in a statistically significant difference of at least about 5 percent, preferably at least about 10 percent, most preferably at least about 20 percent in at least one physical property of a polymer formed by identical processes and from identical formulations except using the same amount of renewable resource based on each of the two substantially different polyols. In an alternative embodiment, at least about 2, preferably at least about 5, more preferably at least about 10, most preferably at least about 25 weight percent increase in renewable resource content is achieved in the total polyol blend by using the combination of different natural oil polyols as compared with using essentially the same formulation except using only one of the natural oil polyols in the combination of natural oil polyols to the maximum extent that results in essentially the same physical and processing properties in a resulting product. In an alternative embodiment, the processes differ by reaction temperature, reaction time, reaction pressure or a combination thereof, preferably by more than reaction temperature, reaction time, reaction pressure, catalyst or a combination thereof; most preferably by more than reaction temperature, reaction time, reaction pressure, catalyst, starting material or a combination thereof.

In an alternative embodiment, the processes preferably differ by at least one unit operation. Preferably, at least one of the processes used to prepare at least one of the natural oil polyols used in the practice of the invention (the first polyol) involves at least one unit operation of hydroformylation (preferably followed by hydrogenation or reduction), epoxidation, alkoxylation, esterification, transesterification, alcoholysis, oxidation, ring opening using a natural oil or derivative thereof while the process of formation of at least one other natural oil polyol (the second natural oil polyol) used in the practice of the invention (that is at least one “different process”) does not involve at least one of the listed unit operations used in preparing the first polyol or involves at least one additional unit operation or, preferably a combination of both.

In another embodiment, the processes outlined in Table 1 are different for purposes of this invention. For purposes of this explanation, the processes outlined in Table 1 are inclusive of variations and improvements of the respective processes, that is they are considered representative of processes that produce similar products. The list of Table 1 is intended to be representative not limiting. While a natural oil polyol made by any process within the skill in the art is useful in the practice of the invention, preferably at least one, and more preferably at least two of the natural oil polyols used in the practice of the invention are selected from those whose preparation, or a variation thereof, is outlined in Table 1. More preferably at least two of the natural oil polyols used in the practice of the invention are prepared by different processes listed in Table 1 or variations thereof.

TABLE 1
VARIOUS PROCESSES FOR PREPARING NATURAL
OIL POLYOLS AND DESCRIPTORS USED FOR EACH

| | INVENTOR, | | TERM USED |
|---|---|---|---|
| | ASSIGNEE or | | HEREIN TO |
| | commercial | SUMMARY | DESCRIBE POLYOL |
| REFERENCE | source | DESCRIPTION | PRODUCT |
| EP106491; U.S. Pat. No. 4,423,162; | Peerman, Rogier | Hydroxymethyl | Transesterified |
| U.S. Pat. No. 4,496,487; U.S. Pat. No. 4,543,369 | (Henkel) | polyols are produced | Hydroxymethyl |
| | | by transesterification | polyols |
| | | of a hydroxy ester | |
| | | monomer with a | |
| | | multifunctional | |
| | | compound having at | |
| | | least 2 active | |
| | | hydrogen atoms. | |
| J. Applied Polymer Sci., | Hu et al. | Treatment of rape | Triethanolamine |
| Vol. 84, 591-597 (2002) | | seed oil with peroxy | alcoholyzed peroxy |
| Wiley | | acid to hydroxylate | acid hydroxylate |
| | | the unsaturation | |
| | | followed by | |
| | | alcoholysis of the | |
| | | product with | |
| | | triethanol amine to | |
| | | increase the | |
| | | hydroxyl value. | |
| US 2005/007062 | Herrington | Epoxidized | (1) epoxidized |
| | | vegetable oil of | vegetable oil |
| | | Petrovic (I) or | (2) hydroformylated |
| | | vegetable oils | oil |
| | | hydroformylated | (3) hydroformylated |
| | | using carbon | adduct of epoxidized |
| | | monoxide and | vegetable oil |
| | | hydrogen (II) or | |
| | | reaction product I | |
| | | and II (III) | |
| US 2006/0041157 | Petrovic | Partially epoxidized | (1) Ring opened |
| | | vegetable oil is ring | partially epoxidized |
| | | opened using a | oil |
| | | proton donor which | (2) vegetable oil ring |
| | | may be an alcohol, | opened partially |
| | | polyol (including | epoxidized oil |
| | | optionally a | |
| | | vegetable based | |
| | | polyol which is | |
| | | optionally | |
| | | hydroformylated and | |
| | | reduced) or water | |
| US2005/0209971 | Kurth et al | (1) Alkoxylated air | (1) alkoxylated air |
| | | blown oil or (2) | blown oil (2) |
| | | transesterified air | transesterified blown |
| | | blown oil with, e.g. | oil |
| | | propoxylated | |
| | | glycerine | |
| US2006/0041155(A1); | David M. Casper, | Conversion products | Hydrogen peroxide |
| US2006/0041156(A1) | et al.(BioBased | where alkene groups | epoxidized vegetable |
| | Chemical) | of unsaturated | oils |
| | | vegetable oils are | |
| | | treated with | |
| | | hydrogen peroxide | |
| | | and an organic acid | |
| | | in the presence of | |
| | | water to yield a | |
| | | hydroxyl group. | |
| US2006/0229375 | Yu-Ling et al. | alkyoxylated | (1) alkoxylated air |
| | (Bayer) | vegetable oil | blown oil; |
| | | hydroxylate where | (2) alkoxylated |
| | | hydroxylation | epoxidized oil; (3) |
| | | includes introduction | alkoxylated |
| | | of hydroxyl groups | hydroformylated oil |
| | | by air oxidation, | |
| | | peroxides or | |
| | | hydroformylation | |
| U.S. Pat. No. 5,516,853 | Schneider et al. | Alkoxylated soybean | Alkoxylated soy oil |
| | | oil | |
| U.S. Pat. No. 6,180,686; U.S. Pat. No. 6,465,569; | Kurth et al. | Oxidation of | Air blown vegetable |
| U.S. Pat. No. 6,624,244 | | vegetable oils by | oil |
| | | blowing with air | |
| U.S. Pat. No. 6,548,609 | Resinas Y | Epoxidation of a | Epoxide of vegetable |
| | Materials | vegetable oil and | oil, ring opened |
| | | reaction with a | |
| | | dialcohol, an | |
| | | alkanolamine or a | |
| | | mixture thereof | |
| U.S. Pat. No. 6,686,435; U.S. Pat. No. 6,107,433; | Petrovic | Reaction product of | Epoxidized vegetable |
| U.S. Pat. No. 6,573,354; U.S. Pat. No. 6,433,121 | | a vegetable oil | oil |
| | | epoxidized e.g. with | |
| | | peroxyacid then | |
| | | reacted with an | |
| | | alcohol and | |
| | | optionally water | |
| | | optionally also | |
| | | reacted with | |
| | | additional | |
| | | epoxidized vegetable | |
| | | oil | |
| U.S. Pat. No. 6,753,402 | BASF | Alkoxylated | Alkoxylated polyester |
| | | polyesters including | polyols |
| | | fatty acid | |
| | | derivatives, in | |
| | | particular dimeric | |
| | | fatty acid | |
| | | derivatives, and | |
| | | derivatives based on | |
| | | castor oil and | |
| | | polyhydroxy fatty | |
| | | acids | |
| WO 2000/014045(A1) | Grosch, G. H. et. | Fatty acid alcohol | Fatty acid alcohol |
| | al. (BASF) | alkoxylates, | alkoxylates |
| | | produced by | |
| | | alkoxylation of | |
| | | monovalent aliphatic | |
| | | alcohols or esters | |
| | | from | |
| | | hydroxycarboxylic | |
| | | acids, either having | |
| | | 6 to 24 carbon | |
| | | atoms, and | |
| | | monovalent or | |
| | | polyvalent alcohols | |
| | | with alkylene oxides | |
| | | in the presence of | |
| | | certain double metal | |
| | | cyanide catalysts. | |
| WO 2001/04225(A1) | Ashvin Shah and | transesterified | Transesterified oils |
| | Tilak Shah, | vegetable oil, e.g. | |
| | (Polymermann) | castor oil or soybean | |
| | | oil, with | |
| | | multifunctional | |
| | | hydroxyl compounds | |
| WO 2004/020497 | Bauer et al. | alkoxylated castor | Alkoxylated vegetable |
| US 2006/0167125 | (BASF) | oil or other oils | oils |
| | | catalyzed using | |
| | | double metal | |
| | | cyanides | |
| WO 2004/096882; | (Dow) | reaction products of | initiated fatty acid |
| WO 2004/096883 | | initiators having | polyester alcohols |
| | | active hydrogen with | |
| | | a vegetable oil based | |
| | | monomer prepared | |
| | | by such processes as | |
| | | hydroformylation of | |
| | | unsaturated fatty | |
| | | acids or esters, | |
| | | followed by | |
| | | hydrogenation of at | |
| | | least a portion of the | |
| | | resulting formyl | |
| | | groups | |
| WO 2006/012344 | (Pittsburg State | vegetable oil polyols | Ring opened |
| | University) | modified by | epoxidized, optionally |
| | | epoxidation and ring | hydroformylated oils |
| | | opening using a ring | |
| | | opener such as a | |
| | | vegetable oil polyol, | |
| | | optionally a reduced | |
| | | hydroformylated | |
| | | vegetable oil derived | |
| | | polyol. | |
| WO 2006/116456 | (Cargill) | polyols formed from | Epoxy ring-opening |
| | | vegetable oils by full | oligomers |
| | | or partial | |
| | | epoxidation and ring | |
| | | opening such that | |
| | | two or more | |
| | | triglyceride based | |
| | | monomers are | |
| | | chemically bonded | |
| | Uniqema | Dimerization of | Dimer diol |
| | | oleic acid and | |
| | | hydrogenation; | |
| | | commercially | |
| | | available | |
| | | representatives | |
| | | including | |
| | | Pripol*2030 | |
| | | Pripol* 2033 polyols | |
| http://hobum.com/en/products/products_4.html | Hobum | Commercially | Polyetherpolyester |
| | Oleochemicals | available | polyol |
| | | polyetherpolyester | |
| | | representatives | |
| | | including. | |
| | | Merginol ™ 204, | |
| | | 205, 206, 235, 8570, | |
| | | 8951 polyols | |
| http://hobum.com/en/products/products_4.html | Hobum | Commercially | Polyester polyol |
| | Oleochemicals | available polyester | |
| | | representatives | |
| | | include Merginol ™ | |
| | | 8364 polyol | |
| | | includes natural oils | Natural polyols |
| | | and oil components, | |
| | | that have more than | |
| | | one hydroxyl group | |
| | | without chemical | |
| | | modification, like | |
| | | castor oil or | |
| | | Lesquerella oil | |

In one embodiment at least one of the types of natural oil polyols represented in Table 1 is used with at least one other type of natural oil polyol represented in the table. Preferably at least two polyols representing different members of the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated), alkoxylated air blown vegetable oil, transesterified air blown oil; fatty acid alcohol alkoxylates; transesterified vegetable oil, alkoxylated vegetable oil; polyester polyol; polyetherpolyester polyol; alkoxylated polyester polyol; initiated fatty acid polyester alcohol; epoxy ring-opening oligomer, and natural polyol are used together in the practice of the invention. More preferably each of the polyols represent different members of the group consisting of epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated) alkoxylated air blown vegetable oil, transesterified air blown oil; initiated fatty acid polyester alcohol; epoxy ring-opening oligomer, and natural polyol are used together in the practice of the invention. Most preferably each of the polyols represent different members of the group consisting of epoxidized vegetable oil at least partially ring opened to produce a secondary hydroxyl group on a main vegetable oil chain, hydroformylated vegetable oil where the formyl groups have been at least partially converted to hydroxymethyl groups; epoxy ring-opening oligomer, and natural polyol are used together in the practice of the invention

Polyols disclosed in WO 04/096882 and WO 04/096883 are most preferred as one of the natural oil polyols in polyol compositions of the invention. These are the reaction products of initiators having active hydrogen such as a polyol or polyamine, amino alcohol or mixture thereof with a vegetable oil based monomer prepared by such processes as hydroformylation of unsaturated fatty acids or esters, followed by hydrogenation or reduction of at least a portion of the resulting formyl groups. Such a polyol is referred to hereinafter as “initiated fatty acid polyester alcohol.” At least one initiated fatty acid polyester alcohol is preferably used with at least one polyol selected from the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated) alkoxylated air blown vegetable oil, transesterified air blown oil; fatty acid alcohol alkoxylates; transesterified vegetable oil, alkoxylated vegetable oil; initiated fatty acid polyester alcohol; epoxy ring-opening oligomer, and natural polyol, more preferably from the group consisting of epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated) alkoxylated air blown vegetable oil, transesterified air blown oil; initiated fatty acid polyester alcohol; epoxy ring-opening oligomer, and natural polyol are used together in the practice of the invention, most preferably consisting of epoxidized vegetable oil at least partially ring opened to produce a secondary hydroxyl group on a main vegetable oil chain, hydroformylated vegetable oil where the formyl groups have been at least partially converted to hydroxymethyl groups; epoxy ring-opening oligomer, and natural polyol are used together in the practice of the invention In one most preferred embodiment at least one initiated fatty acid polyester alcohol is used with at least one different polyol which has been oxidized or epoxidized in some stage of its preparation, more preferably epoxidized, most preferably epoxidized and ring opened to produce an average of at least one secondary hydroxyl group per polyol molecule that remains as a hydroxyl group in the polyol admixed with the initiated fatty acid polyester alcohol.

In another embodiment, different natural oil polyols used in the practice of the invention differ by at least one, preferably 2, more preferably 3, more preferably 4 of the following:
(a) percentage of hydroxyl groups that is primary as compared to secondary;
(b) hydroxyl functionality;
(c) molecular weight;
(d) hydrophilicity (level of ethylene oxide); or
(e) natural oil raw material.

Similarly, the different processes preferably produce natural oil polyol products which differ by at least one, preferably 2, more preferably 3, more preferably 4 of the same qualities.

In the case of a difference in percentage of primary and secondary hydroxyl groups, at least one natural oil polyol preferably has at least about 50, preferably at least about 60, more preferably at least about 70, most preferably at least about 80 percent of its hydroxyl groups as primary while at least one different natural oil polyol has at least 51, preferably at least about 60, more preferably at least about 70, most preferably at least about 90 percent of its hydroxyl groups as secondary. In the case of a difference in hydroxyl functionality, the hydroxyl functionality of at least two different natural oil polyols differs by at least 10, preferably at least about 20, more preferably at least about 30, most preferably at least about 50 percent. In the case of a difference in molecular weight, the molecular weights of at least two different natural oil polyols differ by at least about 10, preferably at least about 20, more preferably at least about 30, most preferably at least about 50 percent. In the case of a difference in hydrophiliciy of at least two different natural oil polyols, the hydrophobicity difference is reflected in difference of at least about 10, preferably at least about 20, more preferably at least about 30, most preferably at least about 40 percent in level of ethylene oxide incorporated into the respective polyol molecules. Different natural oil raw materials means oils extracted from different plants or animals, hence preferably having different distributions of fatty acid esters, different unsaturation (iodine values), or preferably both. Not included in this invention are oils made from same plants grown in different geographical regions or under different climates. However, a plant is considered different from its counterpart genetically altered or otherwise changed to produce a different distribution of fatty acid esters. For instance, natural sunflower oil is different from the oil of sunflowers produced from seed commercially available from Dow AgroSciences LLC, a wholly owned subsidiary of The Dow Chemical Company, under the trade name NATREON™. Any natural oils having a difference of at least about 10 weight percent in the average molecular weight are considered different natural oils for the purposes of this invention.

The combination of natural oil polyols is optionally used with additional or conventional polyols different from natural oil polyols, such as polyether polyols within the skill in the art for forming polymers with other monomers especially polyurethanes, referred to hereinafter as conventional polyol or additional polyol. The conventional or additional polyol is optionally a polymer of one or more alkylene oxides such as ethylene oxide, propylene oxide and 1,2-butylene oxide, or mixtures of such alkylene oxides. Preferred polyethers are polypropylene oxides or polymers of a mixture of propylene oxide and ethylene oxide. Common initiators include alcohols or amines, or aminoalcohols. SAN (Styrene Acrylonitrile) or PHD (PolyHarnstoff) or PIPA (PolylsocyanatepolyAddition) copolymer polyols can also be used. The additional polyol may also be a polyester polyol. These polyester polyols include reaction products of polyols, preferably diols, with polycarboxylic acids or their anhydrides, preferably dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The polyols used in making the polyester polyols preferably have an equivalent weight of 150 or less and include ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like. Polycaprolactone polyols such as those sold by The Dow Chemical Company under the trade name “Tone” are also useful. While any conventional polyol is suitably used, preferred polyols are those which are aliphatic polyols, more preferably polyester, polycaprolactone or polyether, most preferably polyethers.

For the purposes of this invention the polyol combination used to make a polymer of the invention is referred to as the polyol composition. In a polyol composition of the invention at least one first natural oil polyol made by a first process is preferably used in an amount of at least 1 part per hundred parts (PPHP or PHP) of total polyols, more preferably at least about 5, most preferably at least about 10 PHP and, optionally preferably at most about 90, more preferably at most about 80, most preferably at most about 70 PHP of total polyols; while, independently, at least one second natural oil polyol, different from the first, and preferably made by a process different from the first process is preferably present in an amount of at least about 5 PHP, more preferably at least about 10, most preferably at least about 20 PHP and, optionally preferably at most about 90, more preferably at most about 80, most preferably at most about 70 PHP of total polyols. When additional natural oil polyols, different from the first and second polyols, and preferably made by processes different from the first or second processes, they are each independently preferably used in amounts of at least about 1 PHP, more preferably at least about 2, most preferably at least about 5 PHP and, optionally preferably at most about 10, more preferably at most about 15, most preferably at most about 30 PHP of total polyols.

Polyols based on natural oil preferably have an hydroxyl number between 35 and 600. Polyols not based on natural oils preferably have OH number between 20 and 600.

The polyol composition is preferably used to prepare a polymer by reaction with any monomer reactive therewith to produce a polymer. While these polyol compositions are suitable to prepare any such polymer within the skill in the art, they are preferably used, for instance, to prepare polyesters, polyurethanes, polyisocyanurates, polycarbodiimides, polyureas, polyacrylates and combinations thereof, more preferably polyesters and polyurethanes, most preferably polyurethanes, where the term “polyurethane” is used to indicate polymers which are the reaction product of isocyanates with compositions comprising polyols but optionally also containing water, amines or other compounds reactive with isocyanate groups to produce other than urethane functional groups. For instance, urea functional groups are optionally present in a polyurethane. While other polymers are contemplated, reactions of the polyol compositions of the invention with isocyanate compounds are used herein to illustrate the invention but should not be read as the only embodiment of the invention, or to limit the invention. Production of polyesters, polyurethanes and other polymers are well within the skill in the art.

In one embodiment, the natural oil polyol composition is reacted with at least one isocyanate compound having an average of 1.8 or more isocyanate groups per molecule, referred to hereinafter as an isocyanate or polyisocyanate. The isocyanate functionality is preferably at lest about 1.9 and preferably at most about 4, at most about 3.5, most preferably at most about 2.7. Aromatic polyisocyanates are generally preferred based on properties imparted to the product polyurethane. Exemplary polyisocyanates include, for example, m-phenylene diisocyanate, 2,4- and/or 2,6-toluene diisocyanate (TDI), the various isomers of diphenylmethanediisocyanate (MDI), and polyisocyanates having more than 2 isocyanate groups, preferably MDI and derivatives of MDI such as biuret-modified “liquid” MDI products and polymeric MDI, (PMDI) as well as mixtures of the 2,4- and 2,6-isomers of TDI, with the latter most preferred in the practice of the invention. Other preferred isocyanates include methylene diphenyl diisocyanate (MDI) and or its polymeric form (PMDI) for producing the foams of the invention. Aliphatic isocyanates, such as IPDI (isophorone diisocyanates) or HMDI (hexamethylenediisocyanates) can also be used in the practice of the present invention.

In one preferred embodiment of the invention at least one natural oil based prepolymer based on at least one isocyanate and at least one natural oil polyol is used in the practice of the invention. Isocyanates useful in making the prepolymers are any within the skill in the art for the purpose, especially including at least one mentioned herein for use as an isocyanate in making a polyurethane. Making and using prepolymers is within the skill in the art. In an isocyanate-terminated prepolymer process, at least a portion of a polyol composition is reacted with excess di- or polyisocyanate to form an isocyanate-terminated prepolymer containing an average of 2 or more isocyanate groups per molecule. To form such a prepolymer, the isocyanate is used in a stoichiometric excess (NCO:OH) of at least about 1.05:1, more preferably at least about 1.10:1, most preferably at least about 1.20:1, and preferably at most about 10:1, at most about 8:1, most preferably at most about 5:1, leaving a prepolymer having isocyanate functionality. The prepolymer has an equivalent weight of preferably at least about 100, more preferably at least about 300, and preferably at most about 30000, more preferably at most about 20000, most preferably at most about 10000 grams per isocyanate group (equivalent weight). To obtain OH-terminated prepolymers, the isocyanate is used with a stoichiometric deficiency, as disclosed by WO 2006/047434 which is incorporated herein by reference to the fullest extent permitted by law.

Prepolymer preparation is optionally catalyzed, often by tin catalysts such as dibutyltin diacetate and dibutyltin dilaurate. Any of a variety of embodiments are within the scope of the invention. A composition comprising at least 2 different natural oil polyols, optionally with at least one additional polyol that is not of renewable resource origin, is reacted with at least one monomer, preferably an isocyanate monomer, to form a prepolymer which is then reacted with additional polyol, which is optionally the same composition or a different polyol composition that may optionally contain at least one natural oil polyol. In an alternative embodiment, the prepolymer is prepared using only one first natural oil polyol, optionally with at least one additional polyol not of renewable resource origin. Then the prepolymer is reacted with a polyol composition comprising at least one second natural oil polyol, different from the first, optionally also containing additional polyol not of renewable resource origin. In a third embodiment, the prepolymer is prepared using at least one polyol not of renewable origin with substantially no natural oil polyol. Such a prepolymer is reacted with a polyol composition comprising at least 2 different polyols and optionally at least one additional polyol not of renewable resource origin.

In some embodiments, water is used in addition to the natural oil polyol composition and isocyanate or other monomer reactive with polyols to form a polymer in a composition used to make a foam or a microcellular elastomer of the invention. The water is used to achieve blowing of the foam and to form urea segments (hard segments) by reaction with the isocyanate. The amounts of water vary with the purpose of the formulation. For instance, while slab stock polyurethane foams typically use an amount of water from about 2.5 to about 6 parts by weight per hundred parts by weight of total polyol (pphp), viscoelastic foams or microcellular elastomers advantageously use at least about 0.5, preferably at least about 0.6, more preferably at least about 0.8, most preferably at least about 1.0 percent of water by weight, calculated as a percentage of the total weight of polyol components, (pphp) and advantageously at most about 2.5, preferably at most about 2.0, more preferably at most about 1.8, most preferably at most about 1.5 pphp based on total weight of polyol components. In some instances the blowing reactions or density control is achieved by combining water with other blowing agents, for examples hydrocarbons (for instance. cyclo, iso, or n-pentanes) or hydrofluorocarbons (HFCs) and other volatilizable molecules (gaseous or liquids). Adjusted atmospheric pressure or any other method within the skill in the art is also optionally used.

The amount of isocyanate in proportion to the total polyol and water is indicated by the isocyanate index. Similarly, the amount of isocyanate or other monomer reactive with the polyol composition varies with the type and purpose of the resulting polyurethane. Isocyanate indexes within the skill in the art vary from about 50 to about 500.

The formation of urethane foams commonly utilizes at least one catalyst. In some embodiments, at least one catalyst may catalyze a polyol-isocyanate (gelling) reaction or at least one may catalyze a water-isocyanate (blowing) reaction (when water is used as the blowing agent), or both. In making water-blown foams, it is often preferred to use a mixture of at least one catalyst that favors the blowing reaction and at least one other that favors the gelling reaction or one catalyst that does both. These are balanced to achieve sufficient gelling (viscosity) to maintain a desirable cellular structure while achieving sufficient blowing to foam the formulation and, preferably, open many of the cells in the foam. In making a foams a tin catalyst such as dibutyltin dilaurate, (DBTDL) is typically used. Surprisingly, in the practice of the present invention, while DBTDL is useful, stannous octoate (SO) is also a preferred tin catalyst, in some embodiments more preferred. It is also common to produce polyurethane foams using a combination of amine polyols, which combination is useful in the practice of this invention; however, in the practice of this invention use of a single amine catalyst that promotes the blowing reaction is preferred to reduce odor of the final foam product and to simplify the formulations to make the foam products. This invention encompasses polymers, particularly polyurethane polymers and foams thereof made using any catalyst or autocatalytic polyol such as those described in WO 01/58976, within the skill in the art for the purpose.

Catalysts are typically used in small amounts, for example, each catalyst being employed from about 0.0015 to about 5% by weight of the natural oil polyol composition. The amount depends on the catalyst or mixture of catalysts, the desired balance of the gelling and blowing reactions for specific equipment, the reactivity of the polyols and isocyanate as well as other factors familiar to those skilled in the art.

Similarly surfactants, chain extenders, crosslinkers, blowing agents, additives as foaming agents, drying agents, fillers, pigments and the like within the skill in the art are suitable for use in the practice of the invention. In many embodiments, these materials, referred to herein as additives, are admixed, optionally with catalyst, to produce a formulated polyol. An amount of isocyanate corresponding to the isocyanate indexes previously discussed is added and stirred with a formulated polyol. The polyol/isocyanate mixture is then poured into mold. A resulting polyurethane foam can be cured either at room temperature or at higher temperature. These different polyurethane processes are described in “Polyurethane Handbook” by G. Oertel et al, Hanser publisher.

Among additives, chain extenders are often used with prepolymer embodiments of the invention. Preferred chain extenders include aliphatic and cycloaliphatic glycols and oligomeric polyoxyalkylene diols. Diamine chain extenders are also useful in the practice of the invention. Use of chain extenders is well within the skill in the art.

In one embodiment the process for forming a polymer includes steps of (a) forming a natural oil polyol composition comprising at least two different natural oil polyols; (b) admixing at least one catalyst with the natural oil polyol composition to form a catalyst polyol admixture; (c) supplying at least one monomer reactive with the polyol composition in an amount sufficient to form a polymer; (c) admixing the monomer with the catalyst polyol admixture. The polymer is preferably a urethane polymer or polyurethane and the monomer is preferably at least one isocyanate as previously described. In another embodiment the process for forming a foam includes steps of (a) forming a natural oil polyol composition comprising at least two different natural oil polyols and blowing agent; (b) admixing at least one catalyst with the natural oil polyol composition to form a catalyst polyol admixture; (c) supplying an isocyanate in an amount corresponding to an isocyanate index of at least about 50 and at most about 500 and (d) admixing the isocyanate with the catalyst polyol admixture. The blowing agent preferably comprises water and/or a hydrocarbon. These steps optionally occur simultaneously or in any order within the skill in the art to produce a desired product. Optionally, additional components such as auxiliary blowing agents are also added. It should be noted that while the process as described includes admixing at least one natural oil polyol with other polyols to form the natural oil polyol composition; it also includes adding at least one natural oil polyol as an additive to the natural oil polyol composition. In one embodiment of the invention, the process includes steps of (a) forming a first natural oil polyol composition comprising at least one first natural oil polyol; (b) supplying at least one monomer reactive with the polyol composition in an amount sufficient to form a prepolymer; (c) admixing the monomer with the first polyol composition to form a first admixture; (d) exposing the first admixture to reaction conditions to form at least one prepolymer; (e) forming a second admixture comprising the prepolymer and composition reactive with the prepolymer; (f) exposing the second admixture to reaction conditions to form a polymer, wherein the composition reactive with the prepolymer comprises at least one second polyol composition, at least one chain extender or a combination thereof; and wherein the second polyol composition comprises at least one natural oil polyol different from the first natural oil polyol except when the prepolymer already comprises molecular portions originating from at least 2 different natural oil polyols. Thus, at least one natural oil polyol different from the first natural oil polyol is either incorporated into the prepolymer with the first natural oil polyol or is reacted with the prepolymer that incorporates the first natural oil polyol. In either embodiment, at least 2 different natural oil polyols are used to make (incorporated in) the polymer resulting from reaction of the prepolymer and chain extender or second polyol composition. Those skilled in the art will recognize that there can be additional steps, for instance, a prepolymer is optionally prepared with at least one first natural oil polyol, reacted with at least one second natural oil polyol different from at least one first natural oil polyol and then with a chain extender. In each step independently, at least one additional polyol is used.

Foam can be prepared in a so-called slabstock process, or by various molding processes. In a slabstock process, the components are mixed and poured into a trough or other region where the formulation reacts, expands freely in at least one direction, and cures. Slabstock processes are generally operated continuously at commercial scales, but are optionally operated in a discontinuous or box foam process.

Polymers of the invention are useful to make any polymer form or article within the skill in the art, for instance, elastomer, fiber, foam, film, sheet, binding, adhesive, coating, molded object, cast object, container, cushioning, clothing and the like. Foams of the invention are useful for any of the uses of existing foams or uses within the skill in the art, for instance, comfort applications such as mattresses, pillows and cushioning for seating, for sound absorption, for vibration dampening and combinations thereof. Additionally, the foams of the invention are useful in a variety of packaging and cushioning applications, such as mattresses, packaging, bumper pads, sport and medical equipment, helmet liners, pilot seats, earplugs, and various noise and vibration dampening applications.

Objects and advantages of this invention are further illustrated by the following examples. The particular materials and amounts thereof, as well as other conditions and details, recited in these examples should not be used to limit this invention. Unless stated otherwise all percentages, parts and ratios are by weight. Examples of the invention are numbered while comparative samples, which are not examples of the invention, are designated alphabetically.

### EXAMPLES

The following materials are used in making foams of the invention:

PEPO-1 is a 3 functional, 2000 equivalent weight propoxylated polyether polyol with 15 percent ethylene oxide capping commercially available from The Dow Chemical Company under the trade designation Voranol CP 6001 polyol.
PEPO-2 is a 3 functional, 1700 equivalent weight random copolymer of 25 percent propylene oxide and 75 percent ethylene oxide commercially available from The Dow Chemical Company under the trade designation Voranol CP 1421 polyol;
PEPO-3 is a 3 functional, 1200 equivalent weight random copolymer of 87.5 percent propylene oxide and 12.5 percent ethylene oxide commercially available from The Dow Chemical Company under the trade designation Voranol CP 3322
NOPO-1 is a 3-functional natural oil polyol prepared using fatty acids from soy oil and has a primary hydroxyl content of 100 percent with a hydroxyl number (OH#) of 89. It is made by reacting hydroxymethylated soybean fatty acid methyl esters with a 625 molecular weight poly(ethylene oxide) triol made by ethoxylation at 120° C. of glycerol until an equivalent weight of 209 is reached using 0.3 percent final level of KOH and finishing with synthetic magnesium silicate as known in the skill in the art and taught in such references as Polyurethane Handbook, Chemistry, Raw Materials, Processing, Application, Properties edited by G. Oertel, Hanser publisher (1993, second edition) section 3.1.1.2, at a 4:1 molar ratio, using 500 ppm of stannous octoate as the catalyst. The resulting polyether-polyester has a viscosity of 2,700 mPa·s at 21° C., a hydroxyl equivalent weight of 640, Mn of 2500, Mw of 3550, and a polydispersity of 1.44. NOPO-1 has an average of approximately 3.0 hydroxyl groups/molecule. NOPO-1 contains approximately 70% Natural Oil.
NOPO-2 is a natural oil polyol commercially available from Cargill, Inc. under the trade designation BiOH*, which is prepared by a process different from that used to make NOPO-1 (see WO 2006/116456) and has 100% secondary hydroxyl groups.
NOPO-2 contains approximately 90% Natural Oil.
NOPO-3 is castor oil commercially available from Aldrich Chemical. Castor oil is 100% Natural Oil.
NOPO-4 is a natural oil polyol prepared by a process different from that used to make NOPO-1 commercially available from BioBased Systems under the trade designation SoyOil* P38N
NOPO-5 is Dimer diol available from Uniqema under the trade designation Pripol* 2030.
Water is deionized water.
MOD-1 is an organosilicone commercially available from Momentive Performance Materials under the trade designation Niax* L-598.
MOD-2 is an organosilicone commercially available from Degussa under the trade designation Tegostab* B 8715LF
CAT-1 is bis(dimethylaminoethyl)ether catalyst commercially available from Momentive Performance Materials under the trade designation Niax™ A1 catalyst.
CAT-2 is a 33 percent solution of diethylenetriamine in 67 percent dipropylene glycol commercially available from Air Products and Chemicals, Inc. under the trade designation Dabco™ 33LV catalyst;
CAT-4 is a stannous octoate, gelling catalyst used in flexible slabstock foams, commercially available from available from Degussa under the trade designation Cosmos* 29 catalyst.
DEOA is diethanolamine.
NCO-1 is a 80/20 blend of the 2,4- and 2,6-isomers of toluene diisocyanate used in making flexible foams commercially available from The Dow Chemical Company under the trade designation VORANATET™ T-80.
NCO-2 is an MDI prepolymer commercially available from The Dow Chemical Company under the trade designation Specflex* NE 134
NCO-3 is a blend of 80 percent by weight TDI 80/20 and 20 percent by weight PMD1 (polymeric MDI) available from The Dow Chemical Company under the trade designation Specflex* TM-20 isocyanate.

In each example and comparative sample prepared according to “Process A” a foam is prepared by individually metering all of the components and additives (indicated as MOD-1, and MOD-2) of a given formulation except the catalysts and isocyanate, and weighing them into a one quart (0.965 l) capacity metal cup. Component temperatures are approximately 20-30° C. The contents are premixed for 15 seconds at 1800 rpm using a high shear mixer capable of mixing speeds of 3000 rpm, The catalysts which are indicated in the tables are, dispensed by weight, are then added to the stirred components and mixed for an additional 15 seconds at 1800 rpm. An amount designated in the tables of isocyanate (NCO—X) is then added to the cup and vigorously mixed for 3 seconds at 2400 rpm. The cup contents are then poured into a 20×20×20 cm) cardboard box in case of free rise foam. The blow off time and any other distinct reaction characteristics are visually observed and recorded. The resulting foam buns are allowed to cure overnight under a ventilated fume hood. They are then placed in ambient storage for a period of seven days before being submitted for physical property assessment using ASTM test method designation D 3574-03.

In each example and comparative sample prepared according to “Process B” a foam is prepared by individually weighing all of the components and additives (indicated as MOD-1, MOD-2, and MOD-3) of a given formulation including the catalysts, and weighing them into a one liter capacity cup. Component temperatures are approximately 25° C. The components are premixed for 30 seconds at 2,000 rpm using an electric driven stirrer. The isocyanates indicated in the tables are then added to the stirred components and mixed for an additional 5 seconds at 2,000 rpm. The reactants are then poured into a 30×30×10 cm aluminum mold heated at 60° C. that has been sprayed with release agent commercially available from Chem Trend under the trade designation Klueber 3028 release agent. The time when foaming mass reaches the vent holes is referred to in the tables as the mold exit time; whereas the demolding time is maintained at least 4 minutes or longer if foam cannot be properly demolded without deformation. Foam pads are crushed manually at demold to open cells and avoid possibility of shrinkage. Any other distinct reaction characteristics, such as foam odor, skin aspect are observed and recorded if they are not satisfactory. The resulting foam pads are then allowed to cure overnight under a ventilated fume hood. They are then placed in ambient storage for a period of seven days before being submitted for physical property assessment using ASTM and DIN test methods designated in the definitions of the properties given previously.

### Examples 1 and 2 and Comparative Sample A*

For Examples 1 and 2 and Comparative Sample A, slabstock foams made by hand-mixing according to the procedure of “Process A” previously described, using the amounts of components indicated in Table 2 where the amounts are given in parts per hundred parts of total polyol (PHP or PPHP) unless designated differently. (For instance the isocyanate is in terms of index.)

TABLE 2
COMPONENTS AND RESULTS EX1, EX2, CS A*

| | Example/Comparative Sample | | |
|---|---|---|---|
| | Ex 1 | Ex 2 | CS A* |
| PEPO-3 | 60 | 40 | 60 |
| NOBP-1 | 20 | 30 | 40 |
| NOBP-2 | 20 | 30 | |
| water | 2.8 | 2.8 | 2.8 |
| CAT-3 | 0.12 | 0.12 | 0.12 |
| CAT-1 | 0.1 | 0.1 | 0.1 |
| CAT-2 | 0.15 | 0.15 | 0.15 |
| MOD-1 | 1.0 | 1.0 | 1.0 |
| NCO-1 index | 105 | 105 | 105 |
| Observation | OK | OK | Heavy shrinkage |
| Density (kg/m3) | 36 | 37.2 | NA |
| Airflow (cfm) | 1.3 | 0.5 | NA |

*comparative sample, not an example of this invention

By combining NOBP-1 and NOBP-2 it is possible to make open foam with as much as 60 PHP natural oil polyols (EX 2) while NOBP-1 by itself gave very tight, unusable foam at 40 PHP (CS A).

### Examples 1′ and 2′

The procedure using the formulations used in Ex1 for Ex 1′ and that used in Ex 2 for Ex2′ except that NOPO-4 is substituted for NOPO-2 in the amounts of NOPO-2 used in the respective examples. Similar results are obtained.

### Examples 3-5 Using Castor Oil and Natural Oil Derived Polyols

For Examples 3-5, molded foams are made according to the procedure of “Process B” previously described, using the amounts of components indicated in Table 3 where the amounts are given in parts per hundred parts of total polyol (PHP or PPHP) unless designated differently. Demold time 4 minutes. Airflow is measured after foam crushing (breaking of closed cells).

TABLE 3
COMPONENTS AND RESULTS EX 3, EX 4, EX 5

| Example | 3 | 4 | 5 |
|---|---|---|---|
| PEPO-1 | 55 | 55 | 50 |
| NOBP-1 | 40 | 20 | 20 |
| NOBP-2 | | 20 | 20 |
| NOBP-3 | 5 | 5 | 10 |
| PEPO-2 | 2 | 2 | 2 |
| % Natural Oil in | 32.3 | 36.3 | 41.2 |
| polyol blend | | | |
| Water | 3.5 | 3.5 | 3.5 |
| DEOA | 0.5 | 0.5 | 0.5 |
| CAT-1 | 0.05 | 0.05 | 0.05 |
| CAT-2 | 0.4 | 0.4 | 0.4 |
| MOD-2 | 1.5 | 1.5 | 1.5 |
| NCO-2 index | 85 | 85 | 85 |
| Observation at | Tight foam, | Open foam, | Slightly |
| demold | difficult | easy to | tight foam, |
| | to demold | demold | easy to demold |
| Density (kg/m3) | 45.8 | 48.7 | 48.3 |
| Airflow (cfm) | 2.2 | 2.1 | 2.4 |
| 75% CS (%) | 11 | 8.7 | 10.4 |

Examples 3, 4 and 5 show that the combination of NOPO-1 and NOPO-3 in Ex 3 gives a foam, although it is difficult to demold and somewhat less dense than the foams of Examples 4 and 5. The quality improves as NOPO-2 is added in Examples 4 and 5 and even when the amount of NOPO-3 is increased in Example 5. Example 3 gives a higher amount of renewable resource (32.3 weight percent natural Oil) than Comparative Sample C* hereinafter where there is 27.5 weight percent natural oil resulting in essentially the same properties.

When NOPO-4 is substituted for NOPO-2 in Examples 3′, 4′ and 5′ using the formulations for Examples 3, 4 and 5 respectively except with the NOPO-4 substituted in the same amount as that of NOPO-2 in the examples, similar results are obtained.

### Examples 6, 7, and Comparative Samples B, C and D

For Examples 6 and 7 and Comparative Samples B and C, slabstock foams made by hand-mixing according to the procedure of “Process A” previously described, using the amounts of components indicated in Table 2 where the amounts are given in parts per hundred parts of total polyol (PHP or PPHP) unless designated differently.

TABLE 4
COMPONENTS OF EX 6 AND 7 AND CS B AND C

| Example | 6 | 7 | B* | C* |
|---|---|---|---|---|
| PEPO-1 | 75 | 70 | 70 | 60 |
| PEPO-2 | 2 | 2 | 2 | 2 |
| NOBP-1 | 20 | 20 | 30 | 40 |
| NOBP-3 | 5 | 10 | | |
| % Natural oil | 18.6 | 23.5 | 20.6 | 27.5 |
| in polyol blend | | | | |
| water | 3.5 | 3.5 | 3.5 | 3.5 |
| DEOA | 0.5 | 0.5 | 0.5 | 0.5 |
| CAT-1 | 0.05 | 0.05 | 0.05 | 0.05 |
| CAT-2 | 0.4 | 0.4 | 0.4 | 0.4 |
| MOD-2 | 1.5 | 1.5 | 1.5 | 1.5 |
| NCO-2 index | 85 | 85 | 85 | 85 |
| Observation | Open foam, | Open foam, | Open foam, | Tight foam, |
| | easy to | easy to | difficult to | difficult to |
| | demold | demold | demold | demold |
| Density | NA | NA | NA | 47.7 |
| (kg/m3) | | | | |
| Airflow (cfm) | | | | 2.7 |
| 75% CS | | | | 11.8 |

Comparative Samples B and C are not part of this invention.

Examples 7 and 8 show that combination of two different natural oil polyols allow an increase in the level of renewable resources in foams while Comparative Samples B and C show that it is more challenging to use similar amounts of renewable resources when using only one type of natural oil polyol. Indeed Comparative Sample D* (not part of this invention) is based on 50 PHP of NOPO-1 and 50 PHP PEPO-1 (or 34.3 weight percent natural oil content) and same formulation as examples B* and C*. Foam of Comparative Sample C** breaks at demold (splits) since it is very tight and has a 75% CS of 15.9, hence is 80 percent worse than the foam of Example 4.

### Comparative Samples E-I and Example 11

A series of foams are made according to Process B previously described using the formulations indicated in Table 5. Resiliency is measured using the ball rebound test.

TABLE 5
SERIES OF FOAMS

| | Example or comparative sample | | | | | |
|---|---|---|---|---|---|---|
| | E* | F* | G* | H* | I* | 11 |
| NOPO-1 | 20 | 30 | 40 | 50 | | 30 |
| PPHP | | | | | | |
| NOPO-2 | | | | | 20 | 10 |
| PPHP | | | | | | |
| PEPO-1 | 80 | 70 | 60 | 50 | 80 | 60 |
| PEPO-2 | 2 | 2 | 2 | 2 | 2 | 2 |
| water | 3.5 | 3.5 | 3.5 | 3.5 | 3.5 | 3.5 |
| CAT-1/CAT- | 0.05/ | 0.05/ | 0.05/ | 0.05/ | 0.05/ | 0.05/ |
| 2/DEOA | 0.4/0.5 | 0.4/0.5 | 0.4/0.5 | 0.4/0.5 | 0.4/0.5 | 0.4/0.5 |
| MOD-2 | 1.5 | 1.5 | 1.5 | 1.5 | 1.5 | 1.5 |
| NCO-2 index | 85 | 85 | 85 | 85 | 85 | 85 |
| RESILIENCY | 51 | 42 | 40 | 34 | 52 | 43 |
| percent | | | | | | |

*Comparative Sample, not an example of the invention

The results in Table 4 show that resiliency of foams where the amount of NOPO-1 increases in this formulation from 20 to 50 PPHP, show decreasing resiliency. However that property is improved by addition of at least 10 PPHP of a different natural oil polyol like NOPO-2 in Example 11. Similar results are produced in Example 11′ when the same amount of NOPO-4 is substituted for NOPO-2.

### Examples: 12-14 and Comparative Samples J and K

For Examples 12-14 and Comparative Samples G-J, molded foams are made according to the procedure of “Process B” previously described, using the amounts of components indicated in Table 6 where the amounts are given in parts per hundred parts of total polyol unless designated differently. A release agent commercially available from Chem-Trend under the trade designation Klueber.41-2038 is used in each instance.

TABLE 5
Examples 12-14 and Comparative Samples J and K

| Ex or CS | | | | | | |
|---|---|---|---|---|---|---|
| across; | | | | | | |
| component or | | | | | | |
| measurement | OH # or | | | | | |
| down | unit | J | K | 12 | 13 | 14 |
| PEPO-1 | 28 | 90 | 90 | 80 | 60 | 40 |
| NOPO-1 | 89 | 10 | | 10 | 20 | 30 |
| NOPO-2 | 113 | | 10 | 10 | 20 | 30 |
| % Natural | | 6.9 | 8.8 | 15.4 | 30.8 | 46.2 |
| Oil in polyol | | | | | | |
| blend | | | | | | |
| WATER | 6233 | 3.5 | 3.5 | 3.5 | 3.5 | 3.5 |
| DEOA | 1649 | 0.5 | 0.5 | 0.5 | 0.5 | 0.5 |
| CAT-2 | 580 | 0.4 | 0.4 | 0.4 | 0.4 | 0.4 |
| MOD-2 | 0 | 1.5 | 1.5 | 1.5 | 1.5 | 1.5 |
| CAT-1 | 271 | 0.05 | 0.05 | 0.05 | 0.05 | 0.05 |
| PEPO-2 | 33 | 2.0 | 2.0 | 2.0 | 2.0 | 2.0 |
| NCO-2 | % | 85 | 85 | 85 | 85 | 85 |
| INDEX | NCO = | | | | | |
| | 29.5 | | | | | |
| Component | ° C. | 25 | 25 | 25 | 25 | 25 |
| temperature | | | | | | |
| Mould type | Vol. | 9 | 9 | 9 | 9 | 9 |
| Mold temp | ° C. | 60 | 60 | 60 | 60 | 60 |
| Density | g/l | 48 | 48 | 48 | 48 | 48 |
| Demold time | Min | 4 | 4 | 4 | 4 | 4 |
| Foam weight | g | 431 | 429 | 430 | 432 | 433 |
| Exit time | sec | 63 | 67 | 64 | 60 | 58 |
| closed cell^{‡} | | 5 | 3 | 5 | 6 | 6 |
| 75% CS | % CT | 7.4 | 6.3 | 7.9 | 10 | 15.2 |

*Comparative Sample, not an example of the invention. \\
^{‡}Numbers are assigned subjectively to indicate relative degree of closed cells in the foam. High numbers mean tighter foams than lower numbers. Thus, lower numbers are desirable; 6 is considered acceptable for a useful foam.

The data in Table 6 shows that foams closely comparable in terms of processing and compression sets to those where only 10 PPHP of either NOPO-1 or NOPO-2 can be obtained using a total of 20, 40 PPHP of mixtures of the natural oil polyols made by different processes. Even foam of Example 14 having an exceptionally high level of natural oil (46.2 weight percent) has good demolding and a 75% compression set comparable to Comparative Sample C**

The procedures of Examples 12-14 and Comparative Sample J are repeated using the formulations used in Examples 12-14 for Ex 12′-14′, and CS J for CS J′, respectively except that NOPO-4 is substituted for NOPO-2 in the amounts of NOPO-2 used in the respective examples. Similar results are obtained.

Embodiments of the invention include the following:

1. A polyol composition comprising at least one first natural oil polyol made by a first process and at least one second, different natural oil polyol.
2. A composition comprising (A) a blend of (a) at least one first natural oil polyol prepared by a first process, and (b) at least one second natural oil polyol different from the first natural oil polyol, prepared by a second process; or (B) a prepolymer prepared from at least one first natural oil polyol prepared by a first process, and (b) at least one second natural oil polyol different from the first natural oil polyol, prepared by a second process; or (C) at least one prepolymer prepared from (a) at least one first natural oil polyol prepared by a first process, and (b) at least one second natural oil polyol different from the first natural oil polyol, prepared by a second process.
3. A polymer or prepolymer preparable from the polyol composition of any Embodiment herein and at least one monomer polymerizable therewith to form a polymer.
4. A polymer preparable from at least one first natural oil polyol made by a first process and at least one second, different natural oil polyol and at least one monomer polymerizable therewith.
5. A reaction product of (a) at least one prepolymer prepared using at least one first natural oil polyol made by a first process and (b) at least one second natural oil polyol different from the first natural oil polyol.
6. A. foam comprising the polymer of any Embodiment herein wherein the term foam is used as inclusive of all cellular, including microcellular, structures.
7. A process for preparing a polymer comprising (a) supplying a polyol composition of any Embodiment herein and (b) admixing the polyol composition with at least one monomer polymerizable therewith under reaction conditions such that a polymer is formed.
8. A process including steps of (a) forming a first natural oil polyol composition comprising at least one first natural oil polyol; (b) supplying at least one monomer reactive with the polyol composition in an amount sufficient to form a prepolymer; (c) admixing the monomer with the first polyol composition to form a first admixture; (d) exposing the first admixture to reaction conditions to form at least one prepolymer; (e) forming a second admixture comprising the prepolymer and composition reactive with the prepolymer; (f) exposing the second admixture to reaction conditions to form a polymer, wherein the composition reactive with the prepolymer comprises at least one second polyol composition, at least one chain extender or a combination thereof; and wherein the second polyol composition comprises at least one natural oil polyol different from the first natural oil polyol except when the prepolymer already comprises molecular portions originating from at least 2 different natural oil polyols.
9. A process for preparing a foam comprising (a) supplying a polyol composition of any Embodiment herein and (b) admixing the polyol composition with at least one blowing agent and (c) admixing the polyol composition with at least one monomer polymerizable therewith under reaction conditions such that a foam is formed.
10. An article comprising at least one polyol composition, polymer, or foam of any of the preceding Embodiments.
11. The polyol composition, polymer, prepolymer, foam, process, or article of any of the preceding embodiments wherein the second polyol is made by a second process, which is different from the first process.
12. The polyol composition, polymer, prepolymer, foam, process, or article of any of the preceding embodiments wherein each of the natural oil polyols is at least partially derived from renewable resources, preferably at least one vegetable or animal oil or fat, more preferably at least one vegetable oil.
13. The polyol composition, polymer, prepolymer, foam, process, or article of any of the preceding embodiments wherein at least two different natural oil polyols are sufficiently different that a mixture of two or more of the natural oil polyols can be used to make up a larger proportion of a polymer or a polymer with a higher level of renewable content or natural oil than can any of the individual natural oil polyols of the combination when used individually in essentially the same formulation to produce a product of comparable properties; such that a combination of the different natural oil polyols results in at least one improvement in processing, one more desirable physical property in a resulting polymer or end product comprising the polymer or combination thereof than does any natural oil polyol component of the combination individually.
14. The polyol composition, polymer, prepolymer, foam, process, or article of any of the preceding embodiments wherein at least one difference in natural oil polyols is detectable in physical characteristics (preferably selected from hydrophobicity/hydrophilicity, viscosity, color, odor or a combination thereof), chemical structure (preferably selected from molecular weight, functionality, level of natural oil, level of saturates, or a combination thereof), reactivity (preferably selected from percent primary or secondary hydroxyls, amine groups, autocatalytic moieties, or a combination thereof), type of natural oil raw material or a combination thereof.
15. The polyol composition, polymer, prepolymer, foam, process, or article of any of the preceding embodiments wherein different processes vary by more than at least one of reaction temperature, reaction time, reaction pressure, catalyst or starting material unless such variation results in substantially different products, which for the practice of this invention means polyol products sufficiently different to result in a statistically significant difference of at least about any of 5, 10, or 20 percent in at least one physical property in a resulting polymer when each of the polyols is used in essentially the same amounts in a formulation which is otherwise essentially the same.
16. The polyol composition, polymer, prepolymer, foam, process, or article of any of the preceding embodiments wherein the physical or processing properties achieved by using at least 2 different natural oil polyols differ by at least about any of 5, 10, or percent in at least one physical property when each of the polyols is used in essentially the same amounts in a formulation which is otherwise essentially the same.
17. The polyol composition, polymer, prepolymer, foam, process, or article of any of the preceding embodiments wherein use of a polyol composition of at least 2 different natural oil polyols results in an increase of at least about any of 2, 5, 10 or 25 weight percent of total polyol content in renewable resource content over that of using essentially the same formulation except using only one of the natural oil polyols in the combination of natural oil polyols to the maximum extent that results in essentially the same physical and processing properties in a resulting product.
18. The polyol composition, polymer, prepolymer, foam, process, or article of any of the preceding embodiments wherein the processes differ by reaction temperature, reaction time, reaction pressure or a combination thereof, preferably by more than reaction temperature, reaction time, reaction pressure, catalyst or a combination thereof; most preferably by more than reaction temperature, reaction time, reaction pressure, catalyst, starting material or a combination thereof.
19. The polyol composition, polymer, prepolymer, foam, process, or article of any of the preceding embodiments wherein the processes differ by at least one unit operation.
20. The polyol composition, polymer, prepolymer, foam, process, or article of any of the preceding embodiments wherein at least one of the processes used to prepare at least one of the natural oil polyols used in the practice of the invention (the first polyol) involves at least one unit operation of hydroformylation (preferably followed by hydrogenation or reduction), epoxidation, alkoxylation, esterification, transesterification, alcoholysis, oxidation, ring opening using a natural oil or derivative thereof while the process of formation of at least one other natural oil polyol (the second natural oil polyol) used in the practice of the invention (that is at least one “different process”) does not involve at least one of the listed unit operations used in preparing the first polyol or involves at least one additional unit operation or, preferably a combination of both.
21. The polyol composition, polymer, prepolymer, foam, process, or article of any of the preceding embodiments wherein at least one, and more preferably at least two of the natural oil polyols used in the practice of the invention are selected from those whose preparation, or a variation thereof, is outlined in Table 1, more preferably at least two of the natural oil polyols used in the practice of the invention are prepared by different processes listed in Table 1 or variations thereof.
22. The polyol composition, polymer, prepolymer, foam, process, or article of any of the preceding embodiments wherein at least two polyols representing different members of the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated), alkoxylated air blown vegetable oil, transesterified air blown oil; fatty acid alcohol alkoxylates; transesterified vegetable oil, alkoxylated vegetable oil; alkoxylated polyester polyol, polyester polyol, polyetherpolyester polyol, initiated fatty acid polyester alcohol; epoxy ring-opening oligomer, and natural polyol are used together in the practice of the invention; more preferably each of the polyols represent different members of the group consisting of epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated) alkoxylated air blown vegetable oil, transesterified air blown oil; initiated fatty acid polyester alcohol; epoxy ring-opening oligomer, and natural polyol are used together in the practice of the invention; most preferably each of the polyols represent different members of the group consisting of epoxidized vegetable oil at least partially ring opened to produce a secondary hydroxyl group on a main vegetable oil chain, hydroformylated vegetable oil where the formyl groups have been at least partially converted to hydroxymethyl groups; epoxy ring-opening oligomer, and natural polyol are used together in the practice of the invention.
23. The polyol composition, polymer, prepolymer, foam, process, or article of any of the preceding embodiments wherein at least one of the different natural oil polyols is an initiated fatty acid polyester alcohol, and preferably at least one different natural oil polyol is selected from the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated) alkoxylated air blown vegetable oil, transesterified air blown oil; fatty acid alcohol alkoxylates; transesterified vegetable oil, alkoxylated vegetable oil; initiated fatty acid polyester alcohol; epoxy ring-opening oligomer, and natural polyol, more preferably from the group consisting of epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated) alkoxylated air blown vegetable oil, transesterified air blown oil; initiated fatty acid polyester alcohol; epoxy ring-opening oligomer, and natural polyol are used together in the practice of the invention, most preferably consisting of epoxidized vegetable oil at least partially ring opened to produce a secondary hydroxyl group on a main vegetable oil chain, hydroformylated vegetable oil where the formyl groups have been at least partially converted to hydroxymethyl groups; epoxy ring-opening oligomer, and natural polyol.
24. The polyol composition, polymer, prepolymer, foam, process, or article of any of the preceding embodiments wherein at least one initiated fatty acid polyester alcohol is used with at least one different polyol which has been oxidized or epoxidized in some stage of its preparation, more preferably epoxidized, most preferably epoxidized and ring opened to produce an average of at least one secondary hydroxyl group per polyol molecule that remains as a hydroxyl group in the polyol admixed with the initiated fatty acid polyester alcohol.
25. The polyol composition, polymer, prepolymer, foam, process, or article of any of the preceding embodiments wherein different natural oil polyols used in the practice of the invention differ by at least one, preferably 2, more preferably 3, more preferably 4 of the following:
(a) percentage of hydroxyl groups that are primary as compared to secondary;
(b) hydroxyl functionality;
(c) molecular weight;
(d) hydrophilicity (level of ethylene oxide); or
(e) natural oil raw material.
26. The polyol composition, polymer, prepolymer, foam, process, or article of any of the preceding embodiments wherein in a difference in percentage of primary and secondary hydroxyl groups at least one of the different natural oil polyols has at least about any of 50, 60, 70 or 80 percent of its hydroxyl groups as primary while at least one different natural oil polyol has at least about any of 51, 60, 70, or 90 percent of its hydroxyl groups as secondary; in a difference in hydroxyl functionality, the hydroxyl functionality of at least two different natural oil polyols differs by at least about any of 10, 20, 30, or 50 percent; in a difference in molecular, the molecular weights of at least two different natural oil polyols differ by at least about any of 10, 20, 30, or 50 percent; in a difference in hydrophiliciy, the two polyols differ by at least about any of 10, 20, 30, or 40 percent in level of ethylene oxide incorporated into the polyol molecules; in the case of different natural oil raw materials, the oils are extracted from different plants or animals, preferably plants, have distributions of fatty acid esters differing from one another by at least about 10 weight percent in the level of any fatty acid, different unsaturation (iodine values) or a combination thereof; or most preferably there are a combination of these differences, preferred in the order of 1, 2, 3, 4 or 5 of these differences of at least about the preferred amounts.
27. The polyol composition, polymer, prepolymer, foam, process, or article of any of the preceding embodiments wherein the combination of at least 2 different natural oil polyols is used with at least one conventional or additional polyol which is not derived from an animal or plant source, preferably derived from a petroleum source, more preferably which comprises at least one ether group derived from at least one alkylene oxide, more preferably ethylene oxide, propylene oxide and 1,2-butylene oxide, or mixtures of such alkylene oxides, most preferably polypropylene oxide, ethylene oxide or a combination thereof, most preferably comprising ethylene oxide.
28. The polyol composition, polymer, prepolymer, foam, process, or article of any of the preceding embodiments wherein the additional polyol comprises at least one polyester polyol, polycaprolactone polyol or polyether polyol or combination thereof, most preferably at least one polyether polyol or combination thereof.
29. The polyol composition, polymer, prepolymer, foam, process, or article of any of the preceding embodiments wherein the polyol composition comprises at least one first natural oil polyol made by a first process is preferably used in an amount of at least about any of 1, 5, 10, and optionally at most about any of 90, 80, or 70 part per hundred parts (PPHP or PHP) of total polyols; while, independently, at least one second natural oil polyol, different from the first and preferably made by a process different from the first process, is preferably present in an amount of at least about any of 5, 10, or 20 and optionally at most about any of 90, 80, or 70 PHP of total polyols.
30. The polyol composition, polymer, prepolymer, foam, process, or article of any of the preceding embodiments wherein at least one third and optionally more natural oil polyols different from the first and second polyols and, preferably made by processes different from the first or second processes, are used, each independently preferably used in an amount of at least about any of 1, 2, 5 or 10 PHP, and, optionally, preferably at most about any of 10, 15 or 30 PHP of total polyols.
31. The polyol composition, polymer, prepolymer, foam, process, or article of any of the preceding embodiments wherein the polyol composition is reacted with at least one monomer polymerizable therewith to prepare at least one polyester, polyurethane, polyisocyanurate, polycarbodiimide, polyurea, polyacrylate or combination thereof; preferably at least one polyester, polyurethane or combination thereof, most preferably at least one polyurethane.
32. The polyol composition, polymer, prepolymer, foam, process, or article of any of the preceding embodiments wherein at least one monomer is an isocyante, preferably having an average isocyanate functionality of at least about any of 1.8, 1.9, and optionally at most about any of 4, 3.5 or 4 isocyanate groups per molecule.
33. The polyol composition, polymer, prepolymer, foam, process, or article of any of the preceding embodiments wherein at least one prepolymer is formed.
34. The polyol composition, polymer, prepolymer, foam, process, or article of any of the preceding embodiments wherein at least a portion of at least one of the natural oil polyols is reacted with at least a portion of at least one monomer reactive therewith to form a prepolymer.
35. The polyol composition, polymer, prepolymer, foam, process, or article of any of the preceding embodiments wherein at least one prepolymer formed using at least one first polyol composition is reacted with at least one chain extender, second polyol composition or combination thereof; and wherein the combination of first and second polyol compositions comprise at least 2 different natural oil polyols; preferably at least one first natural oil polyol made by a first process is used in making the prepolymer and at least one second natural oil polyol is reacted therewith, at least two different natural oil polyols are used in making the prepolymer, at least two different natural oil polyols are reacted with the prepolymer or a combination thereof; wherein each natural oil polyol is optionally used with at least one additional polyol.
36. The polyol composition, polymer, prepolymer, foam, process, or article of any of the preceding embodiments used in at least one flexible foam.
37. The polyol composition, polymer, prepolymer, foam, process, or article of any of the preceding embodiments used in at least one molded foam.
38. The polyol composition, polymer, prepolymer, foam, process, or article of any of the preceding embodiments wherein the composition, polymer, or foam is used in an article, the process is used to make a composition, polymer or foam used in a product or an article and the product or article comprises at least one elastomer, fiber, foam, film, sheet, binding, adhesive, coating, molded object, cast object, container, cushioning, clothing or combination thereof.
39. The polyol composition, polymer, prepolymer, foam, process, or article of any of the preceding embodiments wherein the product or article comprises a foam, preferably used in an application selected from at least one comfort applications, mattress, pillow, cushioning for seating, sound absorption, vibration dampening, packaging, bumper pads, sport or medical equipment, helmet liners, pilot seats, earplugs, clothing or combination thereof.

1. A composition comprising (A) a blend of (a) at least one first natural oil polyol prepared by a first process, and (b) at least one second natural oil polyol different from the first natural oil polyol, prepared by a second process, wherein one of the at least one first natural oil polyol prepared by a first process or one of the at least one second natural oil polyol different from the first natural oil polyol comprises at least one initiated fatty acid polyester alcohol; or (B) a blend of (a) at least one prepolymer prepared from at least one first natural oil polyol prepared by a first process, and (b) at least one second natural oil polyol different from the first natural oil polyol, prepared by a second process, wherein one of the at least one first natural oil polyol prepared by a first process or one of the at least one second natural oil polyol different from the first natural oil polyol comprises at least one initiated fatty acid polyester alcohol; or (C) at least one prepolymer prepared from (a) at least one first natural oil polyol prepared by a first process, and (b) at least one second natural oil polyol different from the first natural oil polyol, prepared by a second process, wherein one of the at least one first natural oil polyol prepared by a first process or one of the at least one second natural oil polyol different from the first natural oil polyol comprises at least one initiated fatty acid polyester alcohol.

2. The composition comprising of claim 1 wherein at least two natural oil polyols are sufficiently different to result in improved physical or processing properties, satisfactory properties at a higher level of renewable resources or when using a larger amount of combined natural oil polyols in a resulting polymeric product or a combination thereof, all as compared with essentially the same end product produced by essentially the same process but using one of the natural oil polyols alone in an amount equal to that of the combination of natural oil polyols.

3. The composition of claim 1 wherein at least two natural oil polyols are sufficiently different to result in an increase of at least about 2 weight percent in renewable resource content of the total polyol used over that of using essentially the same formulation except using only one of the natural oil polyols of the combination of natural oil polyols to the maximum extent that results in essentially the same physical and processing properties in a resulting product.

4. The composition of claim 1 wherein the processes differ by at least one of reaction temperature, reaction time, reaction pressure or a combination thereof, preferably by more than reaction temperature, reaction time, reaction pressure, catalyst, at least one unit operation, or a combination thereof.

5. The composition of claim 1 wherein at least the first process involves at least one unit operation of hydroformylation, epoxidation, alkoxylation, esterification, transesterification, alcoholysis, oxidation, ring opening using a natural oil or derivative thereof while the second process does not involve at least one of the listed unit operations used in preparing the first polyol or involves at least one additional unit operation or, a combination of both.

6. The composition of claim 1 wherein at least two natural oil polyols represent different members of the group consisting of triethanolamine alcoholyzed peroxy acid hydroxylate, epoxidized vegetable oil at least partially ring opened to produce a secondary hydroxyl group on a main vegetable oil chain, hydroformylated vegetable oil where the formyl groups have been at least partially converted to hydroxymethyl groups; air blown vegetable oil (not alkoxylated or further treated), alkoxylated air blown vegetable oil, transesterified air blown oil; fatty acid alcohol alkoxylates; transesterified vegetable oil, alkoxylated vegetable oil; alkoxylated polyester polyol, polyester polyol, polyetherpolyester polyol, initiated fatty acid polyester alcohol; epoxy ring-opening oligomer, and natural polyol.

7. The composition of claim 1 wherein at least 2 different natural oil polyols differ by at least one of the following:
(a) percentage of hydroxyl groups that are primary as compared to secondary;
(b) hydroxyl functionality;
(c) molecular weight;
(d) hydrophilicity (level of ethylene oxide); or
(e) natural oil raw material.

8. The composition of claim 1 wherein the different natural oil polyols differ in (a) percentage of primary and secondary hydroxyl groups wherein at least one of the different natural oil polyols has at least about 50, percent of its hydroxyl groups as primary while at least one different natural oil polyol has at least about 51, percent of its hydroxyl groups as secondary; (b) hydroxyl functionality by at least about 10 percent; (c) molecular weight differing by at least about 10, percent; (d) hydrophiliciy, differing by at least about 10 percent in level of ethylene oxide incorporated into the polyol molecules; (e) in originating from different natural oil raw materials, (f) having a difference in fatty acid distribution as reflected in at least about a 10 weight percent difference in the level of any fatty acid or ester; or a combination thereof.

9. The composition of claim 1 wherein at least one natural oil polyol comprises at least one natural oil polyol which has been oxidized or epoxidized in some stage of its preparation.

10. The composition of claim 1 wherein at least one of the natural oil polyols is at least one initiated fatty acid polyester alcohol.

11. The composition of claim 1 wherein the combination of at least 2 different natural oil polyols is used with at least one conventional or additional polyol which is not derived from an animal or plant source.

12. A polymer preparable from a composition of claim 1 and at least one monomer interpolymerizable with the polyols.

13. The polymer of claim 12 which is selected from at least one polyester, polyurethane, polyisocyanurate, polycarbodiimide, polyurea, polyacrylate, or combination thereof.

14. The polymer of claim 12 which is at least one polyurethane.

15. A process of preparing a polymer comprising admixing at least one composition of claim 1 with at least one monomer interpolymerizable therewith.

16. An article comprising at least one polymer of claim 12.

17. An article comprising at least one polymer prepared by the process of claim 15.
